(19) United States
(12) Patent Application Publication
(10) Pub. No.: US 2025/0225047 A1
(43) Pub. Date: Jul. 10, 2025

(54) HOST DEVICE FOR TESTING STORAGE DEVICE BASED ON TRANSITION MODEL, METHOD OF OPERATING THE SAME, AND ELECTRONIC DEVICE COMPRISING THE SAME

(71) Applicant: SAMSUNG ELECTRONICS CO., LTD., SUWON-SI (KR)

(72) Inventors: Nakwon LEE, SUWON-SI (KR); Lei GENG, SUWON-SI (KR); Pan YANG, SUWON-SI (KR); Sangyeun CHO, SUWON-SI (KR); Sung-Hyun CHO, SUWON-SI (KR); Jihun HAM, SUWON-SI (KR); Youjin HAN, SUWON-SI (KR)

(21) Appl. No.: 18/925,195

(22) Filed: Oct. 24, 2024

(30) Foreign Application Priority Data
Jan. 10, 2024 (KR) 10-2024-0004383

(51) Int. Cl. G06F 11/34

(52) U.S. Cl. CPC G06F 11/3433; G06F 11/3447

(57) ABSTRACT

A method of operating a host device to test a storage device includes: loading a plurality of state variables and a plurality of transition commands included in a communication interface specification supported by the storage device, generating a plurality of sub-transition models based on the plurality of state variables and the plurality of transition commands, determining a root state value of the plurality of state variables common to a subset of the sub-transition models, generating an integrated transition model based on the subset of the plurality of sub-transition models and the root state value, and providing workloads to the storage device based on the integrated transition model.

### CROSS-REFERENCE TO RELATED APPLICATION(S)

This patent application claims priority under 35 U.S.C. § 119 to Korean Patent Application No. 10-2024-0004383 filed on Jan. 10, 2024, in the Korean Intellectual Property Office, the disclosure of which is incorporated by reference in its entirety herein.

### 1. TECHNICAL FIELD

Embodiments of the present disclosure described herein are directed to a host device, and more particularly, are directed to a host device which tests a storage device based on a transition model, an operating method thereof, and an electronic device comprising the same.

### 2. DISCUSSION OF RELATED ART

A storage device may store data under control of a host device, such as a computer, a smartphone or a smart pad. The storage device includes a device, which stores data in a magnetic disk, such as a hard disk drive (HDD), or a device, which stores data in a non-volatile memory, such as a solid-state drive (SSD) and a memory card.

A non-volatile memory includes a read only memory (ROM), a programmable ROM (PROM), an electrically programmable ROM (EPROM), an electrically erasable and programmable ROM (EEPROM), a flash memory, a phase-change random access memory (PRAM), a magnetic RAM (MRAM), a resistive RAM (RRAM) and a ferroelectric RAM (FRAM).

As semiconductor manufacturing technology develops, the degree of integration of the storage device is increasing, and the capacity of the storage device is also increasing. The high integration of the storage device may reduce manufacturing costs. However, as the scale of the storage device decreases and the structure of the storage device changes due to the high integration of the storage device, reliability of the storage device may be reduced.

### SUMMARY

Embodiments of the present disclosure provide a host device which tests a storage device based on a transition model, an operating method thereof, and an electronic device including the same.

According to an embodiment, a method of operating a host device to test a storage device is provided. The method includes loading a plurality of state variables and a plurality of transition commands included in a communication interface specification supported by the storage device, generating a plurality of sub-transition models based on the plurality of state variables and the plurality of transition commands, determining a root state value of the plurality of state variables that is common to a subset of the sub-transition models, generating an integrated transition model based on the subset of the plurality of sub-transition models and the root state value, and providing the storage device with workloads based on the integrated transition model.

According to an embodiment, a host device which tests a storage device is provided. The host device includes a model generator that generates a plurality of sub-transition models based on a plurality of state variables and a plurality of transition commands, and determines a root state value of the plurality of state variables that is common to a subset of the sub-transition models, and generates an integrated transition model based on the subset of the plurality of sub-transition models and the root state value, and a workload generator that generates workloads including according to a communication interface specification based on the integrated transition model and provides the workloads to the storage device, and the plurality of state variables and the plurality of transition commands are included in the communication interface specification supported by the storage device.

According to an embodiment, an electronic device including a storage device and a host device which tests the storage device is provided. The host device includes a model generator that generates a plurality of sub-transition models based on a plurality of state variables and a plurality of transition commands, and determines a root state value of the plurality of state variables that is common to a subset of the sub-transition models, and generates an integrated transition model based on the subset of the plurality of sub-transition models and the root state value, and a workload generator that generates workloads according to a communication interface specification based on the integrated transition model and provides the workloads to the storage device, and the plurality of state variables and the plurality of transition commands are included in the communication interface specification supported by the storage device, and the storage device sequentially performs the workloads and sequentially provides responses of the workloads to the host device.

### BRIEF DESCRIPTION OF THE FIGURES

The above and other objects and features of the present disclosure will become apparent by describing in detail embodiments thereof with reference to the accompanying drawings.

FIG. 1 is a block diagram of an electronic device according to an embodiment of the present disclosure.

FIG. 2 is a block diagram illustrating a host device of FIG. 1 according to an embodiment of the present disclosure.

FIG. 3 is a flowchart explaining an operating method of a host device according to an embodiment of the present disclosure.

FIG. 4 is a flowchart explaining an operating method of a host device according to an embodiment of the present disclosure.

FIG. 5A is a diagram explaining an example numeric variable and an example transition command according to some embodiments of the present disclosure.

FIG. 5B is a diagram explaining an example event variable and an example transition command according to some embodiments of the present disclosure.

FIG. 6 is a diagram explaining a sub-transition model generator according to some embodiments of the present disclosure.

FIG. 7 is a flowchart explaining an operating method of a sub-transition model generator according to an embodiment of the present disclosure.

FIG. 8 is a diagram explaining a sub-transition model according to an embodiments of the present disclosure.

FIG. 9 is a diagram explaining an integrated transition model according to an embodiment of the present disclosure.

FIG. 10 is a flowchart explaining an operating method of an integrated transition model according to an embodiment of the present disclosure.

FIG. 11 is a flowchart explaining an operating method of a workload generator according to an embodiment of the present disclosure.

FIG. 12 is a flowchart explaining an operating method of a device evaluator according to an embodiment of the present disclosure.

### DETAILED DESCRIPTION

Hereinafter, embodiments of the present disclosure will be described clearly and in detail so that a person skilled in the technical field of the present disclosure may easily practice the embodiments of the present disclosure.

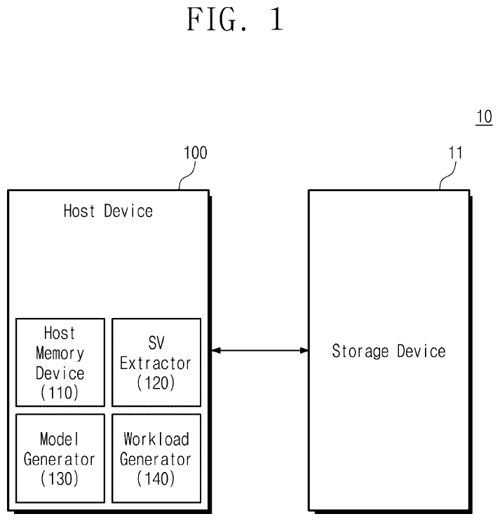

FIG. 1 is a block diagram of an electronic device according to an embodiment of the present disclosure. Referring to FIG. 1, an electronic device 10 includes a host device 100 and a storage device 11. The electronic device 10 may be a computing system configured to process various information, such as a personal computer (PC), a notebook, a laptop, a server, a workstation, a tablet PC, a smartphone, a digital camera or a black box.

The host device 100 may control an overall operation of the electronic device 10. For example, the host device 100 may write data into the storage device 11 or may read data stored in the storage device 11. The host device 100 may provide the storage device 11 with a command and an address for reading data stored in the storage device 11.

In an embodiment, the host device 100 performs a test on the storage device 11. For example, the host device 100 provides the storage device 11 with various commands to test the normal operation of the storage device 11 and may evaluate whether the storage device 11 is operating normally based on responses of the storage device 11 to the commands.

In some embodiments, to efficiently test the storage device 11, the host device 100 may provide valid workloads to the storage device 11. A workload may refer to a set of transition commands which cause an operation of the storage device 11 (or a state transition of the storage device 11). Unlike the host device 100 according to an embodiment of the present disclosure, a host device according to a comparative embodiment tests a device under test (DUT) or the storage device targeted for test by providing randomly generated commands to the DUT or the storage device. Accordingly, some of the commands randomly generated by the host device according to a comparative embodiment may be commands which are invalid in association with the DUT or the test-targeted storage device, that is, may cause low test efficiency. The host device 100 of the present disclosure may implement high test efficiency by generating valid workloads based on the communication interface specification supported by the storage device 11.

The host device 100 may include a host memory device 110, a state variable (SV) extractor 120, a model generator 130, and a workload generator 140. Application programs, file systems or device drivers may be loaded to the host memory device 110. In addition, various software or data running on the host device 100 may be loaded to the host memory device 110. The host memory device 110 may store the communication interface specification. The host memory device 110 may have received the communication interface specification from an external source that is located outside the host memory device 110. The communication interface specification may be a specification of a nonvolatile memory express (NVMe) communication interface or a serial advanced technology attachment (SATA) communication interface. The communication interface specification may be parseable document that indicates the set of commands supported and how to invoke the commands (e.g., information on how each command should be formatted and what parameters each command requires).

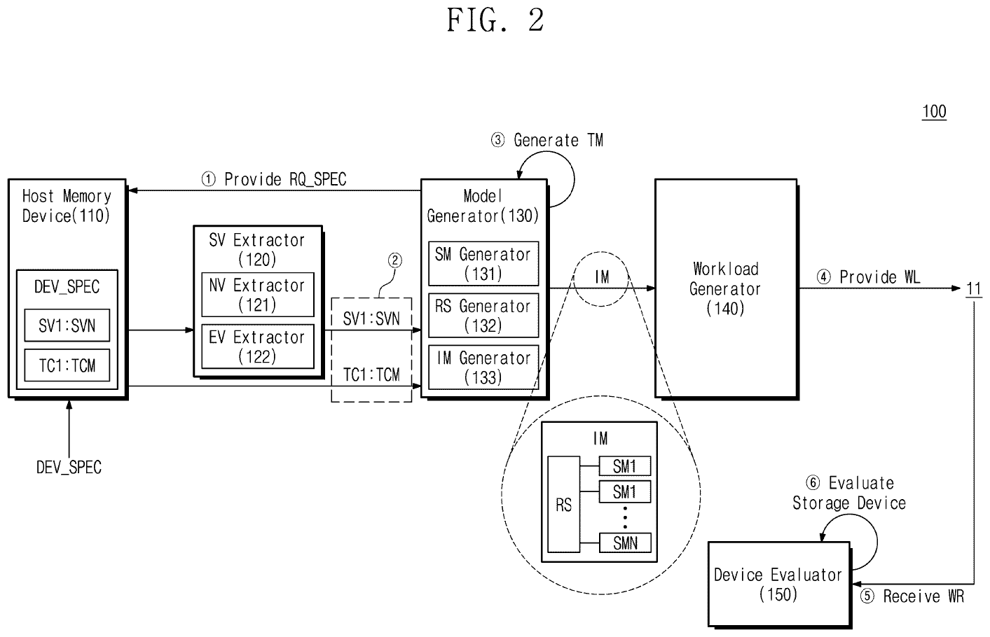

The state variable extractor 120 may extract state variables from the communication interface specification. Each of the state variables represents a process executed by the storage device 11. The state variable extractor 120 may provide the extracted state variables to the model generator 130. The state variable extractor 120 will be described in detail below with reference to FIG. 2. The state variable extractor 120 may be a logic circuit or a program executed by a processor of the host device 100.

The model generator 130 may generate transition models. The model generator 130 may generate transition models (sub-transition models or integrated transition models) so that the host device 100 provides valid commands to the storage device 11. In some embodiments, the model generator 130 generates sub-transition models based on the state variables and transition commands defined in the communication interface specification supported by the storage device 11 and declares a root state value. For example, the model generator 130 may determine a root state value of a state variable or multiple state variables that are common to several sub-transition models. The model generator 130 may generate an integrated transition model based on the sub-transition models and the root state value. The model generator 130 will be described in detail below with reference to FIG. 2. The model generator 130 may be a logic circuit or a program executed by a processor of the host device 100.

The workload generator 140 may provide workloads to the storage device 11. The workload generator 140 may generate a test scenario and may generate workloads for testing on the storage device 11 based on the test scenario and the integrated transition model. The test scenario may indicate the state variables which are subject to test by the host device 100 for the storage device and may indicate a test order of the state variables which are subject to test. The workload generator 140 may provide the generated workloads to the storage device 11. The workload generator 140 will be described in detail below with reference to FIG. 2. The workload generator 140 may be a logic circuit or a program executed by a processor of the host device 100.

The host device 100 may support the NVMe communication interface or the SATA communication interface.

The storage device 11 may operate under control of the host device 100. For example, the storage device 11 may receive commands from the host device 100 and may perform a process based on the commands. The storage device 11 may receive workloads from the host device 100 and may perform commands included in the workloads (or the transition commands which cause a change in the execution state of the storage device 11). The storage device 11 may provide the host device 100 with responses to the commands included in the workloads that its performs.

In some embodiments, the storage device 11 may include a NAND flash memory, but the present disclosure is not limited thereto. The storage device 11 may include one of a variety of storage devices, which retain stored data even after the power supply is cut off, such as a phase-change random access memory (PRAM), a magnetic random access memory (MRAM), a resistive random access memory (RRAM), or a ferroelectric random access memory (FRAM).

FIG. 2 is a block diagram illustrating a host device of FIG. 1 according to an embodiment of the present disclosure. Referring to FIG. 2, the host device 100 may generate workloads for testing the storage device 11. The host device 100 may include the host memory device 110, the state variable extractor 120, the model generator 130, the workload generator 140, and a device evaluator 150.

The host memory device 110 may receive a communication interface specification DEV_SPEC from an external device. The communication interface specification DEV_SPEC may include rules of a communication interface for communication between the host device 100 and the storage device 11 (e.g., a set of commands, a response from the storage device). The host memory device 110 may store the communication interface specification DEV_SPEC.

In some embodiments, the host memory device 110 may provide the communication interface specification DEV_SPEC to the state variable extractor 120 and the model generator 130. For example, the host memory device 110 may receive a specification request signal RQ_SPEC from the model generator 130. The host memory device 110 may provide the communication interface specification DEV_SPEC to the state variable extractor 120 and the model generator 130 in response to the specification request signal RQ_SPEC.

The state variable extractor 120 may extract a plurality of state variables SV1:SVN from the communication interface specification DEV_SPEC. The state variable extractor 120 may receive the communication interface specification DEV_SPEC from the host memory device 110 and may extract the plurality of state variables SV1:SVN from the communication interface specification DEV_SPEC, where “N” is a natural number. The plurality of state variables SV1:SVN may include numeric variables or event variables. The numeric variable may numerically represent a process executed by the storage device 11. For example, a namespace utilization NUSE, defined in the specification of the NVMe communication interface, is a numeric variable which indicates the number of logical blocks allocated within the namespace of the storage device. An event variable may represent an event which occurs within the storage device 11. For example, an asynchronous event defined in the NVMe communication interface specification is an event variable which indicates whether the asynchronous event occurs within the storage device.

In some embodiments, the state variable extractor 120 may include a numeric variable extractor 121 and an event variable extractor 122. The numeric variable extractor 121 may extract a numeric variable from the communication interface specification DEV_SPEC. For example, the numeric variable extractor 121 may extract only numeric variables from among numeric constants and numeric variables included in the communication interface specification DEV_SPEC. The numerical constant may indicate that when the storage device 11 operates under control of the host device 100, the number of processes executed in the storage device 11 does not change.

In some embodiments, the event variable extractor 122 may extract an event variable from the communication interface specification DEV_SPEC. For example, the communication interface specification DEV_SPEC may define how the transition commands change the internal state of the storage device. Since the transition commands are performed by the storage device 11, the event variable extractor 122 may extract events occurring inside the storage device 11 as event variables.

The state variable extractor 120 may provide the plurality of state variables SV1:SVN to the model generator 130.

The model generator 130 may generate transition models (e.g., sub-transition models SM1:SMN or an integrated transition model IM), where “M” is a natural number. The model generator 130 may include a sub-transition model generator 131, a root state value generator 132, and an integrated transition model generator 133.

In some embodiments, the sub-transition model generator 131 receives a plurality of transition commands TC1:TCM from the numeric variable extractor 121. The sub-transition model generator 131 may extract the plurality of transition commands TC1:TCM from the communication interface specification DEV_SPEC stored in the host memory device 110. For example, the sub-transition model generator 131 may extract commands such as a Write Uncorrectable Command or a User Data Out Command, which may increase the value of the NUSE from the NVMe communication interface specification.

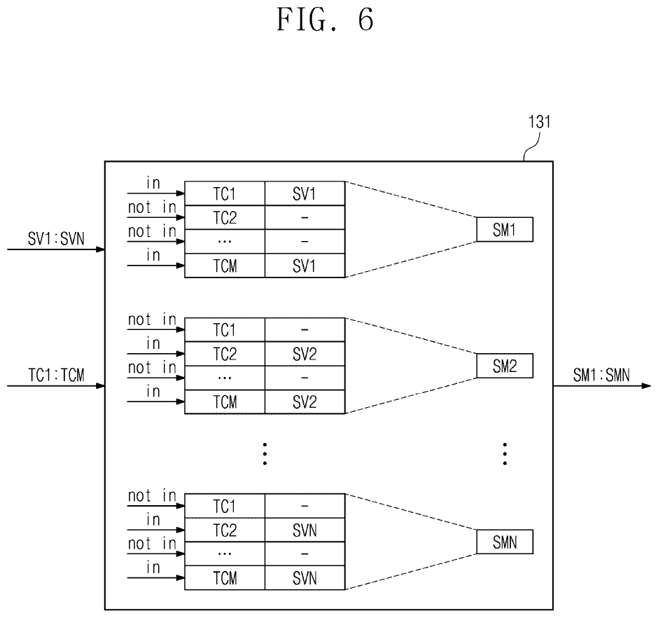

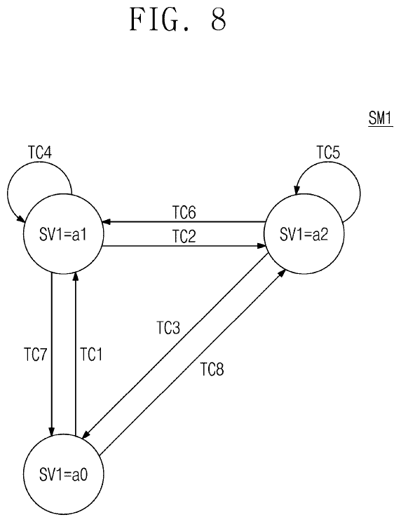

In some embodiments, the sub-transition model generator 131 generates a plurality of sub-transition models SM1:SMN. For example, the sub-transition model generator 131 may generate the plurality of sub-transition models SM1:SMN based on the plurality of state variables SV1:SVN and the plurality of the transition commands TC1:TCM. One sub-transition model among the plurality of sub-transition models SM1:SMN may model one state variable among the plurality of state variables SV1:SVN. In other words, the sub-transition model and the state variable may have a one-to-one relationship. The sub-transition model will be described in detail below with reference to FIG. 6 and FIG. 8.

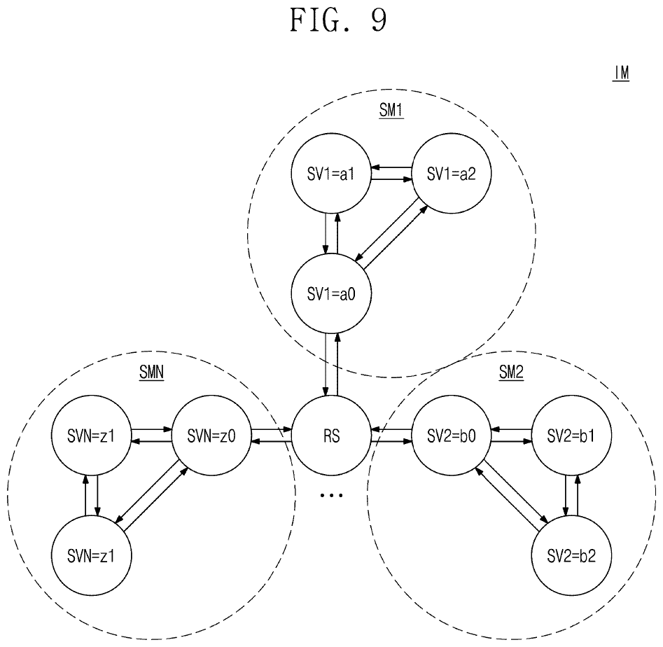

The root state value generator 132 may declare a root state value RS. For example, the root state value generator 132 may determine the root state value RS based on each of values respectively corresponding to the plurality of state variables SV1:SVN. The root state value RS may be linked to all the values of the plurality of state variables SV1:SVN. In other words, there may be a transition from the root state value RS to a random value of any state variable among the plurality of state variables SV1:SVN, and from a random value of any state variable to the root state value RS. The root state value RS will be described in detail below with reference to FIG. 9.

The integrated transition model generator 133 may generate an integrated transition model IM. For example, the integrated transition model generator 133 may generate the integrated transition model IM based on the plurality of sub-transition models SM1:SMN and the root state value RS. The integrated transition model IM may include the plurality of sub-transition models SM1:SMN and the root state value RS.

In some embodiments, the integrated transition model generator 133 determines transition commands for sequential transitions from the integrated transition model IM to one sub-transition model among the plurality of sub-transition models SM1:SMN, to a root state value, and to another sub-transition model. The transition command for a transition from one sub-transition model to the root state value and the transition command for a transition from the root state value to another sub-transition model may respectively be a dummy command. In other words, the integrated transition model IM may include the transition commands for sequential transitions from a random value of one state variable (e.g., one of multiple values which a state variable may have) to the root state value and a random value of another state variable. The integrated transition model IM will be described in detail below with reference to FIG. 9.

In some embodiments, the model generator 130 provides the generated integrated transition model IM to the workload generator 140.

The workload generator 140 may provide workloads WL to the storage device 11. For example, the workload generator 140 may generate a test scenario and may generate workloads for testing the storage device 11 based on the test scenario and the integrated transition model.

In some embodiments, the workload generator 140 determines which state variables among the plurality of state variables SV1:SVN should be tested in the test scenario. In addition, the workload generator 140 may determine the test order of the state variables to be tested.

The workload generator 140 may generate the workloads WL based on sub-transition models corresponding to the state variables which are subject to test according to the test scenario. One workload WL may include the transition commands for transitions from the root state value RS through the values of one state variable and back to the root state value RS according to a sub-transition model.

In some embodiments, the workload generator 140 determines whether to perform the workloads WL simultaneously or sequentially to test the state variables which are subject to test.

The device evaluator 150 may evaluate the operation of the storage device 11. For example, the device evaluator 150 may evaluate whether the storage device 11 operates normally under control of the host device 100 based on responses to the workloads WR received from the storage device 11. The device evaluator 150 may be implemented by a logic circuit or a program that is executed by a processor.

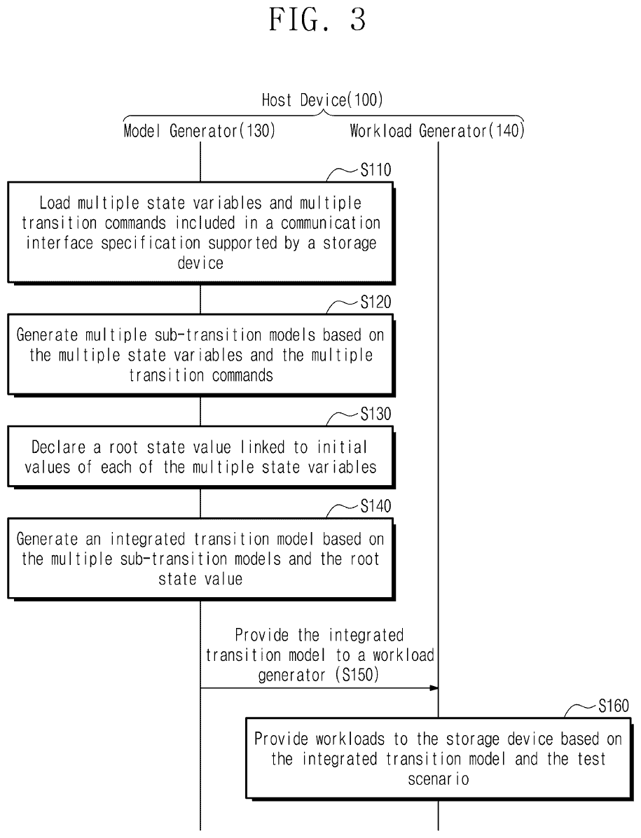

FIG. 3 is a flowchart explaining an operating method of a host device according to an embodiment of the present disclosure. Referring to FIG. 2 and FIG. 3, the host device 100 performs a test on the storage device 11 of FIG. 2. According to an embodiment, the host device 100 generates an integrated transition model, and generates workloads for testing the storage device 11 of FIG. 2 based on an integrated transition model and a test scenario.

In operation S110, the model generator 130 loads one or more state variables and one or more transition commands included in the communication interface specification supported by the storage device 11. The model generator 130 may load the state variables and the transition commands from the state variable extractor 120 and the host memory device 110 of FIG. 2, respectively.

In operation S120, the model generator 130 generates multiple sub-transition models based on the state variables and the transition commands. One sub-transition model may correspond to one state variable. The sub-transition model may match the transition commands necessary for a transition of the value of the state variable with the state variable. The sub-transition model will be described in detail below with reference to FIG. 6.

In operation S130, the model generator 130 declares a root state value linked to each of initial values respectively corresponding to the plurality of state variables. The root state value may be linked to other random values. For example, the model generator 130 may declare the root state value which is linked to an initial value, a first value, a second value of the first state variable, and an initial value, a first value, a second value of the second state variable.

In operation S140, the model generator 130 generates an integrated transition model based on the sub-transition models and the root state value. To move from one sub-transition model to another sub-transition model within the integrated transition model, it may have to move through the root state value.

In operation S150, the model generator 130 provides the workload generator 140 with the integrated transition model.

In operation S160, the workload generator 140 provides workloads to the storage device based on the integrated transition model and the test scenario. The workload generator 140 may select the sub-transition models which are subject to test from the generated sub-transition models based on the test scenario and may generate workloads based on the selected sub-transition models. The workload generator 140 may provide the generated workloads to the storage device 11.

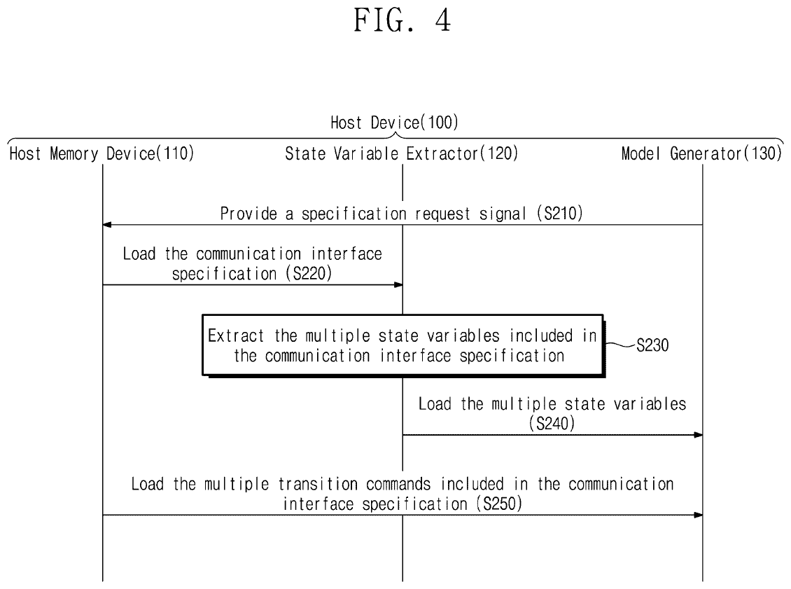

FIG. 4 is a flowchart explaining the operating method of the host device according to an embodiment of the present disclosure. Referring to FIG. 4, the host device 100 may extract the plurality of state variables and the plurality of transition commands from the communication interface specification stored in the host memory device 110.

In operation S210, the model generator 130 provides a specification request signal to the host memory device 110. The host memory device 110 may store the communication interface specification (e.g., the NVMe communication interface specification or the SATA communication interface specification).

In operation S220, the state variable extractor 120 loads the communication interface specification from the host memory device 110. In some embodiments, the state variable extractor 120 may include the numeric variable extractor 121 and the event variable extractor 122 of FIG. 2. The host memory device 110 may output the communication interface specification to the state variable extractor 120 in response to the specification request signal RQ_SPEC.

In operation S230, the state variable extractor 120 extracts one or more state variables included in the communication interface specification. In some embodiments, the state variable extractor 120 may extract the plurality of state variables including numeric variables or event variables. The state variable extractor 120 may output the extracted state variables to the model generator 130.

In operation S240, the model generator 130 loads the plurality of state variables from the state variable extractor 120.

In operation S250, the model generator 130 loads the plurality of transition commands included in the communication interface specification received from the host memory device 110. For example, the host memory device 110 may output the communication interface specification to the model generator 130 in response to the specification request signal RQ_SPEC. The plurality of transition commands may be defined in the communication interface. In other words, the model generator 130 may extract the transition commands defined in the communication interface specification.

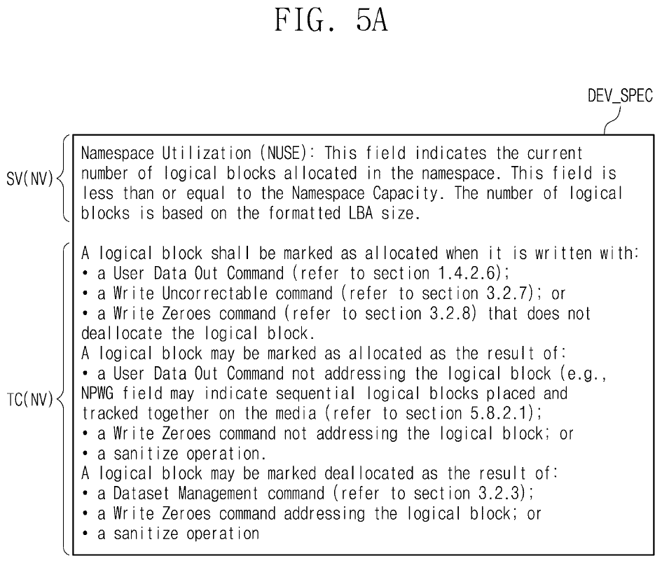

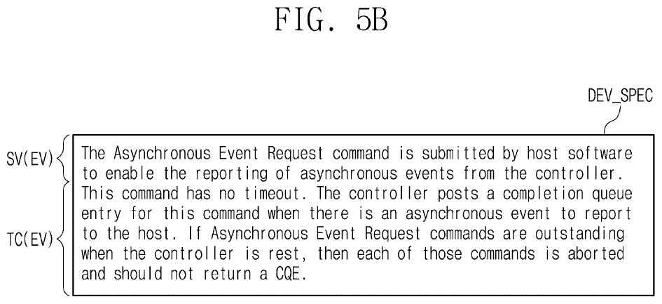

FIG. 5A is a diagram explaining an example numeric variable and an example transition command according to some embodiments of the present disclosure. Referring to FIG. 5A, the communication interface specification DEV_SPEC (e.g., the NVMe communication interface specification) may include numeric variables SV (NV) and transition commands TC (NV). For example, the communication interface specification DEV_SPEC may include the namespace utilization NUSE as one numeric variable SV (NV). The NUSE indicates the current number of logical blocks allocated within the namespace of the storage device. In other words, the communication interface specification DEV_SPEC, like the NUSE, may include the numerical variables SV (NV) which may numerically represent a process executed by the storage device. The namespace may be one of multiple NVMe namespaces, which are portions of storage on a NVMe solid state drive that can be individually formatted and used as if they are separate physical storage devices.

For example, the communication interface specification DEV_SPEC may include the User Data Out Command (e.g., a store command), the Write Uncorrectable command (e.g., instructs drive to mark one or more LBAs as uncorrectable), a sanitize operation (e.g., used to delete data in a secure manner), and the like as the transition commands TC (NV) corresponding to the NUSE. The User Data Out Command may be marked as a logical block assigned to the namespace. In other words, the value of the NUSE may increase as the User Data Out Command is performed by the storage device.

FIG. 5B is a diagram illustrating example event variables and example transition commands according to some embodiments of the present disclosure. Referring to FIG. 5B, the communication interface specification DEV_SPEC (e.g., the NVMe communication interface specification) may include event variables SV (EV) and transition commands TC (EV). For example, the communication interface specification DEV_SPEC may include the asynchronous event as one event variable SV (EV). The communication interface specification DEV_SPEC may directly or indirectly describe the event variables SV (EV). The asynchronous event may indicate whether the asynchronous event occurs within the storage device. In other words, the communication interface specification DEV_SPEC may include event variables SV (EV) representing events which occur within the storage device, such as the asynchronous event.

For example, the communication interface specification DEV_SPEC may include an Asynchronous Event Request command as the transition commands TC (EV) corresponding to the asynchronous event. The Asynchronous Event Request command may enable a controller of the storage device to report to the host device whether an asynchrony has occurred within the storage device. In other words, the Asynchronous Event Request command may change the storage device to a state in which the storage device report whether an asynchrony occurs in the host device.

FIG. 6 is a diagram illustrating the sub-transition model generator 131 according to an embodiment of the present disclosure. Referring to FIG. 6, the sub-transition model generator 131 generates the plurality of sub-transition models SM1:SMN. For example, the sub-transition model generator 131 may generate the plurality of sub-transition models SM1:SMN based on the plurality of state variables SV1:SVN and the plurality of the transition commands TC1:TCM.

In some embodiments, the sub-transition model generator 131 matches the transition commands TC1:TCM corresponding to the plurality of state variables SV1:SVN. For example, the sub-transition model generator 131 may determine that a first transition command TC1 and a M-th transition command TCM correspond to a first state variable SV1, and may match the first transition command TC1 and the M-th transition command TCM to the first state variable SV1. The sub-transition model generator 131 may generate a first sub-transition model SM1 based on the first state variable SV1 and the matched transition commands. The sub-transition model generator 131 may determine transition commands respectively corresponding to the state variables for the second to N-th state variables SV2: SVN, and may generate second to N-th sub-transition models SM2: SMN. Here, “N” and “M” are natural numbers.

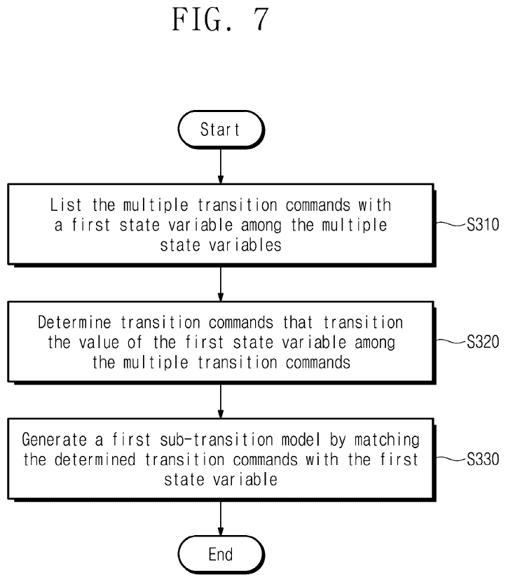

FIG. 7 is a flowchart explaining an operating method of the sub-transition model generator according to an embodiment of the present disclosure. Referring to FIG. 2 and FIG. 7, the sub-transition model generator 131 of FIG. 2 generates the plurality of sub-transition models based on the plurality of state variables and the plurality of transition commands.

In operation S310, the sub-transition model generator 131 lists the plurality of transition commands with the first state variable among the plurality of state variables.

In operation S320, the sub-transition model generator 131 determines transition commands for a transition of the value of the first state variable among the plurality of transition commands. In other words, the sub-transition model generator 131 may determine transition commands corresponding to the first state variable.

In operation S330, the sub-transition model generator 131 generates a first sub-transition model by matching the determined transition commands with the first state variable.

In some embodiments, the sub-transition model generator 131 may repeat operations S310 to S330 for the second to N-th state variables to generate the second to N-th sub-transition models.

FIG. 8 is a diagram illustrating a sub-transition model according to an embodiment of the present disclosure. Referring to FIG. 8, the sub-transition model may indicate which transition command changes the value of the state variable and to what value the transition command changes the value. For example, the first sub-transition model SM1 may indicate the value of the first state variable SV1 changes due to execution by transition commands. The first state variable SV1 may be set to an initial value a0 and then transition to a first value a1 or a second value a2. However, the scope of the present disclosure is not limited thereto, and the state variable may include other numbers of values, and the initial value a0 is not limited to a specific value and may be any value which the first state variable SV1 may have. In some embodiments, the values included in the state variable may be grouped (or discretized) into “K” numbers. For example, when a state variable can be set to any one of “L” values, the “L” values may be divided into “K” groups, where “K” and “L” are natural numbers, and “K” is less than “L”.

For example, execution of the first transition command TC1 may cause the value of the first state variable SV1 to transition from the initial value a0 to the first value a1. In other words, when the host device 100 of FIG. 2 provides the first transition command TC1 to the storage device 11 of FIG. 2, the state of the storage device 11 may change from the initial state (a state corresponding to the initial value a0) to the first state (a state corresponding to the first value a1). Further, execution of a fourth transition command TC4 may maintain the value of the first state variable SV1 at the first value a1.

As described above, the sub-transition model may indicate to which value the value of the state variable transitions by which transition command. However, the number of transition commands required for a transition from the value of the state variable to another value is not limited to one, but may be two or more.

FIG. 9 is a diagram illustrating an integrated transition model according to an embodiment of the present disclosure. Referring to FIG. 9, the integrated transition model IM includes the plurality of sub-transition models SM1:SMN and the root state value RS. The integrated transition model IM may determine transition commands for transitions between each of values respectively corresponding to the plurality of state variables SV1:SVN and the root state value RS. For example, the integrated transition model IM may determine transition commands for a transition from the initial value a0, the first value a1, or any other random value of the first state variable SV1 to the root state value RS.

In some embodiments, moving from one sub-transition model within the integrated transition model IM to another sub-transition model may require moving through the root state value RS. For example, for moving from the first sub-transition model SM1 to a second sub-transition model SM2, it may be necessary to sequentially transition from the initial value a0 of the first state variable SV1 to the root state value RS and to an initial value b0 of the state variable SV2. However, this is only illustrated as an example for convenience of explanation and it may be possible to sequentially transition from another random value of the first state variable SV1 to the root state value RS and the other random value of the second state variable.

In some embodiments, moving through the root state value RS within the integrated transition model IM may reduce the number of workloads generated for testing the storage device rather than moving without going through the root state value RS. For example, when moving without going through the root state value RS, there may be nine paths to move from the first sub-transition model SM1 to the second sub-transition model SM2 (there are nine paths to move from one of the three values a0, a1, a2 of the first state variable SV1 to one of the three values b0, b1, b2 of the second state variable SV2). On the contrary, when moving through the root state value RS, only one path may be required to move from the first sub-transition model SM1 to the second sub-transition model SM2. In other words, for testing multiple state variables, it may be fast and efficient to move through the root state value RS when moving from one sub-transition model to another sub-transition model.

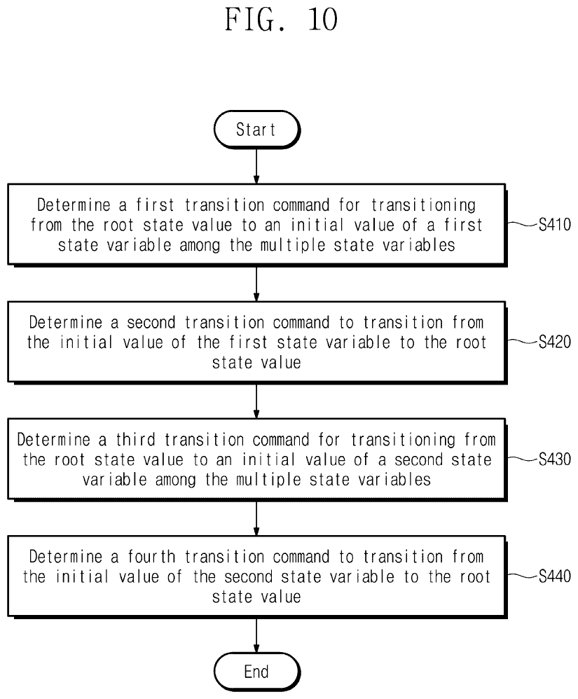

FIG. 10 is a flowchart explaining an operating method of an integrated transition model according to an embodiment of the present disclosure. Referring to FIGS. 2 and 10, the integrated transition model generator 133 of FIG. 2 may generate an integrated transition model.

In operation S410, the integrated transition model generator 133 determines a first transition command for a transition from the root state value to the initial value (e.g., a0) or any other value (e.g., a1 or a2) of the first state variable among the plurality of state variables.

In operation S420, the integrated transition model generator 133 determines a second transition command for a transition from the initial value (e.g., a0) of the first state variable or any other random value (e.g., a1 or a2) to the root state value.

In operation S430, the integrated transition model generator 133 determines a third transition command for a transition from the root state value to the initial value (e.g., b0) or any other random value (e.g., b1 or b2) of the second state variable among the plurality of state variables.

In operation S440, the integrated transition model generator 133 determines a fourth transition command for a transition from the initial value (e.g., b0) or any other value (e.g., b1 or b2) of the second state variable to the root state value.

In some embodiments, the integrated transition model generator 133 may determine transition commands for transitions between each initial value of the different state variables or other random value and the root state value. However, the number of transition commands required to transition between the state variable value and the root state value is not limited to one, and may be zero or more. For example, a transition command for a transition between one state variable and the root state value may be a dummy command.

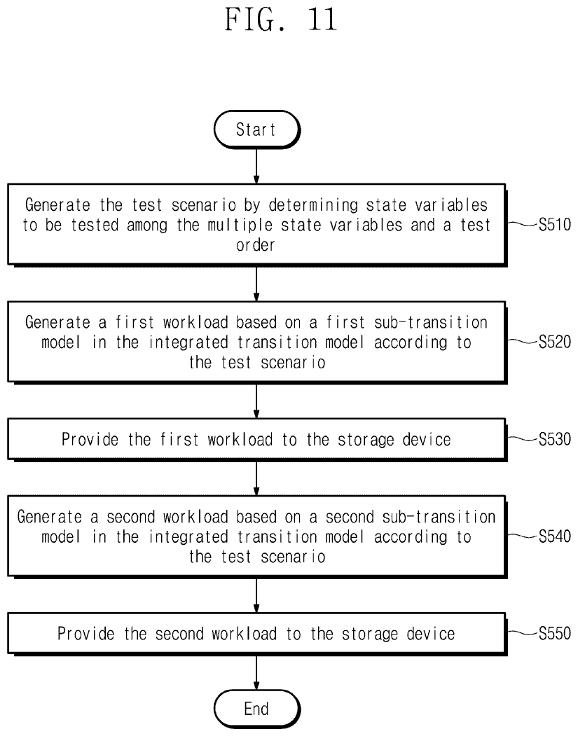

FIG. 11 is a flowchart explaining an operating method of the workload generator according to an embodiment of the present disclosure. Referring to FIG. 2 and FIG. 11, the workload generator 140 of FIG. 2 may generate workloads.

In operation S510, the workload generator 140 generates a test scenario by determining state variables to be tested among the plurality of state variables and a test order. The workload generator 140 may generate the test scenario arbitrarily or in a predetermined manner.

In operation S520, the workload generator 140 generates a first workload based on the first sub-transition model in the integrated transition model according to the test scenario. The first workload may be a set of sequential transition commands for a transition of the value of the first state variable (corresponding to the first sub-transition model). In some embodiments, the first workload may include transition commands for transitions between the root state value and the initial value (e.g., a0) of the first state variable or any other value (e.g., a1 or a2). For example, the first workload may include a first command for transitioning the first state variable from the root state value to the initial value, a second command for transitioning the first state variable from the initial value to the first value a1, a third command for transitioning the first state variable from the initial value to the second value a2, etc.

In operation S530, the workload generator 140 provides the first workload to the storage device.

In operation S540, the workload generator 140 generates a second workload based on the second sub-transition model in the integrated transition model according to the test scenario.

In operation S550, the workload generator 140 provides the second workload to the storage device.

In some embodiments, the workload generator 140 may generate the first and second workloads sequentially or simultaneously according to the test scenario. When the workload generator 140 simultaneously generates a plurality of workloads, the workload generator 140 provides the first workload to the storage device 11, and may provide the second workload to the storage device 11 before receiving a first response to the first workload from the storage device 11.

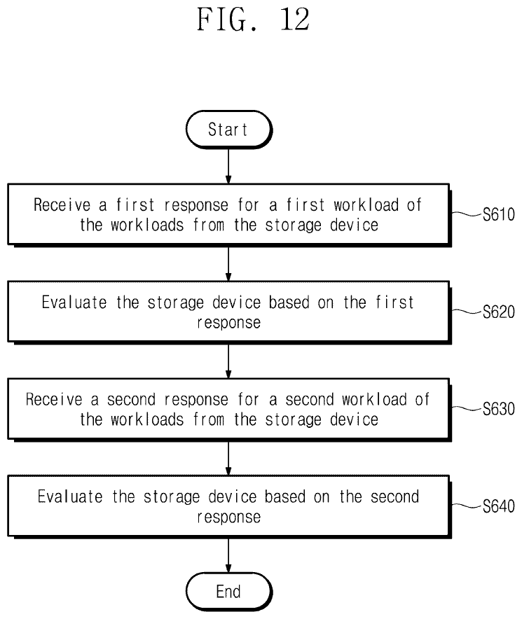

FIG. 12 is a flowchart explaining an operating method of a device evaluator 150 according to an embodiment of the present disclosure. Referring to FIG. 2 and FIG. 12, the device evaluator 150 of FIG. 2 may evaluate the storage device 11 based on the responses to workloads from the storage device 11 of FIG. 2.

In operation S610, the device evaluator 150 receives the first response for the first workload among the workloads from the storage device 11.

In operation S620, the device evaluator 150 evaluates the storage device 11 based on the first response. In other words, the device evaluator 150 may evaluate whether the storage device 11 operates normally according to the first control (corresponding to the first workload) of the host device. For example, the first response may indicate whether the storage device 11 operates normally or abnormally after executing the commands of the first workload.

In operation S630, the device evaluator 150 receives a second response for the second workload among the workloads from the storage device.

In operation S640, the device evaluator 150 evaluates the storage device based on the second response. For example, the second response may indicate whether the storage device 11 operates normally or abnormally after executing the commands of the second workload.

The responses which the device evaluator 150 receives from the storage device 11 are not limited to the two workloads. The device evaluator 150 may respectively perform evaluations on the responses to the workloads received from the storage device 11. In other words, the host device 100 may test the storage device 11 based using the workloads and determine whether the test has succeeded or failed based on the evaluations.

According to an embodiment of the present disclosure, a host device which tests a storage device based on a transition model, an operating method thereof, and an electronic device including the same are provided.

Additionally, by generating a test scenario of a storage device based on a communication interface, a host device which verifies the storage device accurately and efficiently, an operating method thereof, and an electronic device including the same are provided.

While the present disclosure has been described with reference to embodiments thereof, it will be apparent to those of ordinary skill in the art that various changes and modifications may be made thereto without departing from the spirit and scope of the present disclosure.

What is claimed is:

1. A method of operating a host device to test a storage device, the method comprising:
loading a plurality of state variables and a plurality of transition commands included in a communication interface specification supported by the storage device;
generating a plurality of sub-transition models based on the plurality of state variables and the plurality of transition commands;
determining a root state value of the plurality of state variables that is common to a subset of the sub-transition models;
generating an integrated transition model based on the subset of the plurality of sub-transition models and the root state value; and
providing workloads to the storage device based on the integrated transition model.

2. The method of claim 1, wherein the host device comprises:
a model generator;
a host memory device; and
a state variable extractor, and
wherein the loading of the plurality of state variables and the plurality of transition commands included in the communication interface specification supported by the storage device comprises:
providing, by the model generator, a specification request signal to the host memory device;
loading the communication interface specification from the host memory device to the state variable extractor in response to the specification request signal;
extracting, by the state variable extractor, the plurality of state variables included in the communication interface specification;
loading the plurality of state variables from the state variable extractor to the model generator; and
loading the plurality of transition commands from the host memory device to the model generator in response to the specification request signal.

3. The method of claim 2, wherein each of the state variables includes a numeric variable or an event variable, and
wherein the numeric variable numerically represents a process executed by the storage device,
wherein the event variable represents an event which occurs within the storage device,
wherein the state variable extractor includes a numeric variable extractor and an event variable extractor,
wherein the numeric variable extractor extracts numeric variables from the communication interface specification, and
wherein the event variable extractor extracts event variables from the communication interface specification.

4. The method of claim 1, wherein the plurality of sub-transition models include a first sub-transition model including a first state variable, and
wherein the generating of the plurality of sub-transition models based on the plurality of state variables and the plurality of transition commands comprises:
listing each of the plurality of transition commands with the first state variable;
determining transition commands for a transition of a value of the first state variable among the listed plurality of transition commands; and
generating a first sub-transition model by matching the determined transition commands with the first state variable.

5. The method of claim 1, wherein the host device includes a model generator,
wherein a first sub-transition model among the plurality of sub-transition models includes a first state variable configured to be set to one of an initial value, a first value, and a second value, and
wherein the model generator generates a first sub-transitional model by:
determining a first transition command whose execution transitions the first state variable from the initial value to the first value;
determining a second transition command whose execution transitions the first state variable from the first value to the second value; and
determining a third transition command whose execution transitions the first state variable from the second value to the initial value.

6. The method of claim 1, wherein the integrated transition model includes transition commands for transitioning the selected state variable to and from the root state value.

7. The method of claim 1, wherein the generating of the integrated transition model based on the plurality of sub-transition models and the root state value comprises:
determining a first transition command for a transition from a first state variable of a first sub-transition model among the plurality of sub-transition models to the root state value;
determining a second transition command for a transition from the root state value to the first state variable;
determining a third transition command for a transition from a second state variable of a second sub-transition model among the plurality of sub-transition models to the root state value;
determining a fourth transition command for a transition from the root state value to the second state variable; and
based on the first to fourth transition commands, generating at least a portion of the integrated transition model by integrating the first and second sub-transition models with the root state value.

8. The method of claim 1, wherein the providing of the workloads to the storage device based on the integrated transition model comprises:
generating a test scenario by determining state variables to be tested among the plurality of state variables;
generating a first workload based on a first sub-transition model in the integrated transition model according to the test scenario;
providing the first workload to the storage device;
generating a second workload based on a second sub-transition model in the integrated transition model according to the test scenario; and
providing the second workload to the storage device.

9. The method of claim 8, wherein the host device sequentially generates the first and second workloads, and provides the second workload to the storage device after receiving a response to the first workload.

10. The method of claim 8, wherein the host device provides the first workload and the second workload to the storage device before receiving a response to the first workload.

11. The method of claim 8, wherein the first workload further comprises:
a first transition command for a transition from the root state value to one of values of a first state variable corresponding to the first sub-transition model; and
a second transition command for a transition from the value of the first state variable to the root state value.

12. The method of claim 1, wherein further comprising:
receiving a first response to a first workload among the workloads from the storage device;
performing a first evaluation of the storage device based on the first response;
receiving a second response for a second workload among the workloads from the storage device; and
performing a second evaluation of the storage device based on the second response.

13. The method of claim 1, wherein the communication interface specification is either a Non-Volatile Memory express (NVMe) specification or a Serial Advanced Technology Attachment (SATA) specification.

14. A host device which tests a storage device, comprising:
a model generator configured to generate a plurality of sub-transition models based on a plurality of state variables and a plurality of transition commands, to determine a root state value of the plurality of state variables that is common to a subset of the sub-transition models, and to generate an integrated transition model based on the plurality of sub-transition models and the root state value; and
a workload generator configured to generate workloads according to a communication interface specification based on the integrated transition model and to provide the workloads to the storage device,
wherein the plurality of state variables and the plurality of transition commands are included in the communication interface specification supported by the storage device.

15. The host device of claim 14, further comprising:
a host memory device and a state variable extractor,
wherein the host device is further configured to provide a specification request signal to the host memory device,
wherein the host memory device stores the communication interface specification, and provides the communication interface specification to the state variable extractor and the model generator in response to the specification request signal, and
wherein the state variable extractor extracts the plurality of state variables included in the communication interface specification from the host memory device, and provides the plurality of state variables to the model generator.

16. The host device of claim 14, wherein the model generator includes a sub-transition model generator, a root state value generator, and an integrated transition model generator,
wherein the sub-transition model generator determines transition commands among the plurality of transition commands for a transition of each of values respectively corresponding to the plurality of state variables, and generates the plurality of sub-transition models by matching the determined transition commands with the plurality of state variables, respectively,
wherein the root state value generator determines the root state value based on each of the values respectively corresponding to the plurality of state variables, and
wherein the integrated transition model generator determines transition commands among the plurality of transition commands for transitions between the root state value and each of the values respectively corresponding to the plurality of state variables.

17. The host device of claim 14, wherein the workload generator determines state variables to be tested among the plurality of state variables and a test order, and generates workloads based on some sub-transition models in the integrated transition model according to the test order, and provides the workloads to the storage device sequentially.

18. The host device of claim 14, further comprising:
a device evaluator,
wherein the device evaluator sequentially receives responses to the workloads received from the storage device and evaluates the storage device based on the responses.

19. An electronic device comprising:
a storage device; and
a host device configured to test the storage device,
wherein the host device comprises:
a model generator configured to generate a plurality of sub-transition models based on a plurality of state variables and a plurality of transition commands, to determine a root state value of the plurality of state variables that is common to a subset of the sub-transition models, and to generate an integrated transition model based on the subset of the plurality of sub-transition models and the root state value;
a workload generator configured to generate workloads according to a communication interface specification based on the integrated transition model, and to provide the workloads to the storage device;
wherein the plurality of state variables and the plurality of transition commands are included in the communication interface specification supported by the storage device, and
wherein the storage device sequentially performs the workloads and sequentially provides responses to the workloads to the host device.

20. The electronic device of claim 19, wherein the host device performs an evaluation of the storage device based on the responses.
